(19) United States
(12) Patent Application Publication
(10) Pub. No.: US 2002/0110335 A1
(43) Pub. Date: Aug. 15, 2002

(54) Packaging and alignment methods for optical components, and optical apparatus employing same

(76) Inventors: David K. Wagner, San Jose, CA (US); Harald Guenther, Los Gatos, CA (US); William K. Bischel, Menlo Park, CA (US); Jim Weijian Li, Fremont, CA (US); Nina D. Morozova, San Jose, CA (US)

Correspondence Address: HAYNES BEFFEL & WOLFELD LLP, P O BOX 366, HALF MOON BAY, CA, 94019, US

(21) Appl. No.: 09/784,945

(22) Filed: Feb. 14, 2001

(51) Int. Cl. G02B 6/36

(52) U.S. Cl. 385/89

(57) ABSTRACT

Roughly described, a submount has a standoff structure protruding from its surface. An optical component is pressed against the standoff structure until tilt and planar non-uniformities are removed, and then bonded to the submount using an adhesive placed in the wells between the protrusions of the standoff structure. The standoff structure preferably has a total surface area contacting the optical component which is much smaller than the area by which the optical components overlap the submount. The optical component mounted in this manner can be an optical array component (including an optical fiber array), or a component having only a single optical port. A second optical component can be attached to the submount in the same manner, greatly simplifying the vertical alignment problems between the two components.

### BACKGROUND

1. Field of the Invention

The invention relates generally to packaging of optical and optoelectronic components, and more specifically to techniques for optical alignment and attachment of planar and planar array optical waveguides.

2. Description of Related Art

In the manufacturing of optoelectronic and lightwave systems, optical alignment is an important requirement beyond the electrical contact, mechanical support, and reliability requirements existing for electronic packaging. Alignment of different devices and chips, such as micron-scale laser diodes (herein abbreviated as LDs), electro-optic devices, single mode fibers, and other optical waveguiding structures, is necessary because not all useful functionalities in the current art can be obtained in the same substrate material. Thus the type of packaging where it is necessary to couple optical energy between waveguiding structures in and on different chips and substrates (herein called “integrated optics” or IO packaging) is widely employed in such systems.

A number of techniques are known for IO packaging. Active alignment of an optical fiber to a single-emitter LD, followed by adhesive attachment, soldering or laser welding, is commonly employed in construction of telecommunication components, such as 980 nm LD pumps for erbium-doped fiber amplifiers (EDFAs) and 1.5 μm transmission LDs for wavelength division multiplexing (WDM) signal transmitters.

In the standard procedure employed for packaging these components, the LD is soldered emitter-side down to a submount, with the output facet situated near the edge of the submount to avoid clipping the divergent LD beam. A lensed fiber, which is a single-mode optical fiber with a spherical lens or chisel tip formed on one end typically by fusion (melting), grinding, or chemical etching, is brought into proximity to the output facet of the operating laser and its position is adjusted with sub-micron accuracy to maximize the launched power into the fiber, measured by a detector coupled to the other end of the fiber. At maximum coupled power, the lensed fiber is attached to the submount by a means such as UV-cured epoxy adhesive, laser welding, or soldering. The fully active fiber alignment process embodied by the standard procedure is both cumbersome and slow, and although it can provide remarkably good coupling efficiency between the diode laser and fiber (in excess of 60%) it does not lend itself well to high volume, high yield and low cost manufacturing. As a further limitation, the foregoing procedure has been used only for single-emitter, individual LD geometries, and consequently mounting fixtures and handling apparatus used to adjust the fiber position are limited to single fibers and single-emitter LDs.

The prior art also includes various techniques for packaging optical or optoelectronic components utilizing passive or semi-passive optical alignment methods. In one example of such a technique, a single-emitter LD or alternatively a photo-detector chip is coupled to a planar light circuit or single optical fiber using a silicon optical bench or a similar submount. In this technique, an appropriate thickness of solder is deposited to provide a robust mechanical, electrical and thermal contact for the LD, and the LD is flip-chip bonded to the submount (i.e., bonded with the emitter or active side down) using molten solder. The absolute vertical distance of the emitter relative to the submount will depend on the solder thickness and the bonding pressure. In some cases the LD or detector chip is mounted directly onto a lead carrier with an etched region defined to accept the chip. Attempts have also been made in the prior art to align multi-channel integrated laser arrays with integrated optoelectronic chips or with fiber arrays by employing a self-aligned solder assembly with mechanical stops and misaligned solder joints.

A major shortcoming of prior packaging techniques utilizing passive or semi-passive alignment of optical components is that such techniques generally cannot provide a sufficiently high degree of alignment precision. In particular, it is difficult or impossible to simultaneously achieve highly precise vertical alignment (alignment in the direction perpendicular to the major plane of the components) in each optical channel between multi-channel components, such as an LD emitter array and an integrated optics chip, due to (inter alia) solder thickness and bonding pressure variations across the lateral dimension of the components. Problems with misalignment in the vertical direction may be exacerbated by the occurrence of warping, bowing, curling or other planar nonuniformities in the components to be aligned, and/or by the presence of foreign particles between on or both of the components and the submount. The failure of prior art techniques to effect precise and uniform vertical alignment between corresponding channels of multi-channel optical components results in high and non-uniform coupling losses, thereby limiting the usefulness of devices manufactured such techniques.

In view of the foregoing discussion, there is a need in the art for a packaging and alignment method which facilitates precise and uniform optical alignment between optical components, which accommodates component planar uniformities and the presence of foreign particles, and which may be implemented relatively easily and inexpensively.

### SUMMARY OF THE INVENTION

According to the invention, roughly described, the above-described problems and others are overcome by providing a submount with a standoff structure protruding from its surface. An optical component is then juxtaposed against the standoff structure and bonded to the submount using an adhesive (solder, epoxy, etc.) placed in the wells between the protrusions of the standoff structure. By placing the adhesive in the wells rather than on the contact surface of the standoff structure, the prior art problem of adhesive deposition thickness affecting optical alignment is eliminated.

If it is desired to remove planar non-uniformities in the optical component, then the step of juxtaposing can be performed by pressing the optical component against the standoff structure, optionally using a flip-chip bonder having a compliant layer on its vacuum holding chuck, until tilt and planar non-uniformities are removed.

The effectiveness of this technique permits the optical component to be an optical array component such as a laser diode array, a photodetector array, an integrated optical chip, or an optical fiber array, but the techniques can also be used with components having only a single optical port. If the optical component is to be aligned with a second optical component, then the second optical component can be attached to the submount in the same manner. Thus vertical alignment can be achieved simply, inexpensively and precisely between multiple ports of optical array components.

The use of a standoff structure, which preferably has a total surface area contacting the optical components which is smaller, preferably much smaller, than the area by which the optical components overlap the submount, can substantially reduce the probability that alignment will be degraded by a foreign particle becoming lodged between the standoff structure and the optical component. Although not essential, it is advantageous for optimum vertical alignment and minimum curvature of the optical component along the emitting or receiving edge thereof, if the standoff structure includes at least three consecutive contact portions disposed along a straight line parallel to the subject edge of the optical component, mutually isolated from each other along that straight line.

The method can be applied to the mounting and alignment of optical fiber arrays, by providing the submount with longitudinal parallel recesses in a top surface thereof, optionally formed by the standoff structure. A fiber holder is also provided, having a plurality of parallel v-grooves in an undersurface thereof. Each of the v-grooves has a respective optical fiber affixed therein The fiber holder is then attached to the submount, the fibers in the v-grooves of the fiber holder depending below the undersurface of the fiber holder and into the recesses in the submount.

### BRIEF DESCRIPTION OF THE DRAWINGS

FIG. 1 is a symbolic diagram of a planar array package of this invention.

FIG. 2 is a cross-sectional view taken along line A-A in FIG. 1.

FIGS. 3A-C show three alternative standoff structure designs.

FIG. 4 is a cross-sectional view taken along a line parallel to the side facets of two curled chips on a submount.

FIG. 5 illustrates the dimensional requirements for standoff structures according to the present invention.

FIG. 6 illustrates an alternative stepped standoff structure design according to the present invention, shown in cross-sectional view taken along a line parallel to the side facets of two optical components.

FIG. 7 is a cross-sectional view taken along a line parallel to the end facet of an optical component on a submount.

FIG. 8 is a cross-sectional symbolic view of a compliant chuck, at full contact of the array component and reference surface.

FIG. 9 is a process flow diagram of a packaging method according to the invention.

FIG. 10 is a symbolic view of a preferred embodiment of a planar array package of this invention, showing a packaged diode laser array and lithium niobate waveguide array.

FIG. 11 is a cross-sectional view taken along line C-C identified in FIG. 10.

FIG. 12 is a process flow diagram of a preferred packaging method for a preferred embodiment.

FIG. 13 illustrates use of a standoff structure of the present invention along with existing v-groove technology.

FIG. 14 illustrates use of a standoff structure of the present invention utilized such that existing v-groove technology is enhanced.

### DETAILED DESCRIPTION

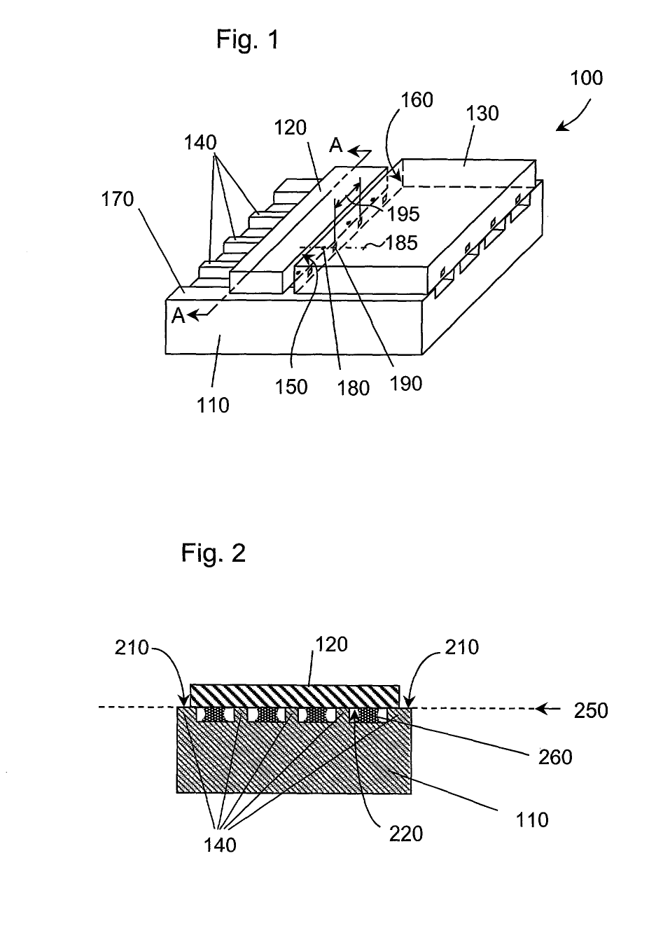

FIG. 1 shows a planar array package 100 constructed according to an embodiment of the invention. A first optical array component 120 is shown to be optically aligned with respect to a second optical array component 130, wherein both components are located on a submount 110. The optical array components 120, 130 may take the form of photodiode (PD) array chips, laser diode (LD) array chips, or optical fiber arrays, for example. Each optical array component 120, 130 is provided with a plurality of parallel optical ports 180, 190 respectively. In preferred embodiments of the invention, each optical array component 120, 130 will comprise at least two optical ports, typically three or more, located along the same edge of the component. Each optical array component 120, 130 therefore includes an array of two or more optical ports, located respectively along the subject edges 150 and 160 of the components 120 and 130. The optical ports 180, 190, for example, may take the form of waveguide inputs and outputs, positioned such that the subject edges 150, 160 of the optical components are substantially perpendicular to the optical axes of the waveguide inputs and outputs, with the spacing between the individual waveguide inputs and outputs being substantially the same in both components, at least on the sides facing each other. In this manner, the optical ports 180 of the first optical array component 120 and the optical ports 190 of the second optical array component 130 can communicate with each other if they are arranged in such a way that enough of the optical energy to be useful for a desired application, which energy is emitted from one of the ports, would be captured by the other optical port. The second optical port need not necessarily be perfectly aligned with the first optical port. As used herein, two ports are “aligned” with each other if they share a common optical axis. Two ports “can communicate” with each other if they are aligned or are misaligned by no greater than a desired tolerance, and also if they are aligned (or misaligned by no more than a desired tolerance) with an optical path which includes an optical redirector such as a reflector, refractor, re-emitter, or other such component.

A standoff structure 140, which provides a reference surface (described below), allows for relative vertical optical alignment of the array components 120 and 130. The standoff structure 140 may be fabricated on the first major surface 170 of the submount 110 by photolithography and/or selective etching of the material comprising the submount. Alternatively, the standoff structure 140 may be fabricated by laser ablation, or by depositing a layer of material and defining the standoff structure by photolithography and a solvent or etchant, or by positioning and attaching pieces of material preformed in a predetermined thickness and shape of a standoff structure 140, or by a combination of the aforementioned techniques. The standoff structure 140 may alternatively be formed on the optical array component 120, 130 itself, instead of the submount 110, or partially on the optical array component and partially on the submount. As shown, the standoff structure 140 comprises several discrete standoffs, or ribs, running substantially perpendicular to the subject edges 150, 160 of the optical components 120, 130 and substantially longitudinally to the waveguide.

The function of the standoff structure 140 is made clear with reference to FIG. 2, which represents a cross-sectional view taken along the line A-A in FIG. 1. The tops 210 of all the desired portions of the standoff structure 140 define a virtual reference surface 250. In the illustration shown, the standoff structure 140, comprising several discrete standoffs, does not contact every point on the reference surface 250, hence the standoff structure itself only partially defines the reference surface. It is from this reference surface 250, on the submount 110, against which the optical array components 120 (shown), 130 (not shown) are placed to provide relative vertical alignment. This approach makes use of the flip-chip bonding technique, that is the bonding of components with the circuit side (also variously referred to as the active or top side) facing a corresponding surface of submount 110. It is noted that in the integrated optics art, several components of a given type are typically fabricated simultaneously by photolithographic and planar processing techniques on a wafer, which is then separated into identical smaller units referred to as chips, devices, or components. As a consequence of the method of construction, the active and passive optical and electronic circuit structures of the array components, such as waveguides, p-n junctions, and other structures known in the art, are disposed on or near the top or circuit side of the component.

The array components 120, 130 are so constructed, by means such as diffusion, epitaxial growth, or adding thin film layers to the surface using evaporation, sputtering, or other means known in the art, that when the top surfaces of the two components lie in a common plane, the centroids of the optical mode intensity profiles are vertically aligned for maximum overlap and consequently, maximum optical coupling when also laterally aligned. Thin film material added to adjust the distance of optical mode centroids from the top or active surface of an optical component may comprise, for example, silicon dioxide (SiO₂) deposited by sputtering or by ion-beam assisted deposition (which provides the ability to control film thicknesses to an accuracy of a few nanometers). The material may alternatively comprise a metal such as gold. In certain implementations of the height adjustment process, the thin film material is patterned (via photolithography or other suitable prior art technique) into a set of discrete “pads” spatially corresponding to the upper surfaces 210 of standoff structure 210. Patterning of the thin film material into discrete pads covering only a portion of the optical component surface significantly reduces (as compared to implementations wherein a continuous thin film layer is deposited) the development of stresses arising from a thermal expansion mismatch between the thin film and component materials. Alternatively, different height deposited standoff structure 140 can be utilized, as described below. Other techniques which may be used to compensate for differences in the centroids-to-surface distance include interposing, during the assembly process, preformed metal or dielectric material pads of appropriate thickness between the component having the smaller centroids-to-surface distance and the underlying portions of standoff structure 140.

The term “vertical” is used herein to designate a direction perpendicular to the major surface of an array component, and also, to the reference surface 250. For LD emitters and many IO waveguides the transverse mode diameter of the waveguide in the vertical direction is typically very small and substantially narrower than the divergence in the horizontal direction, making the vertical position of the waveguide the most critical alignment direction.

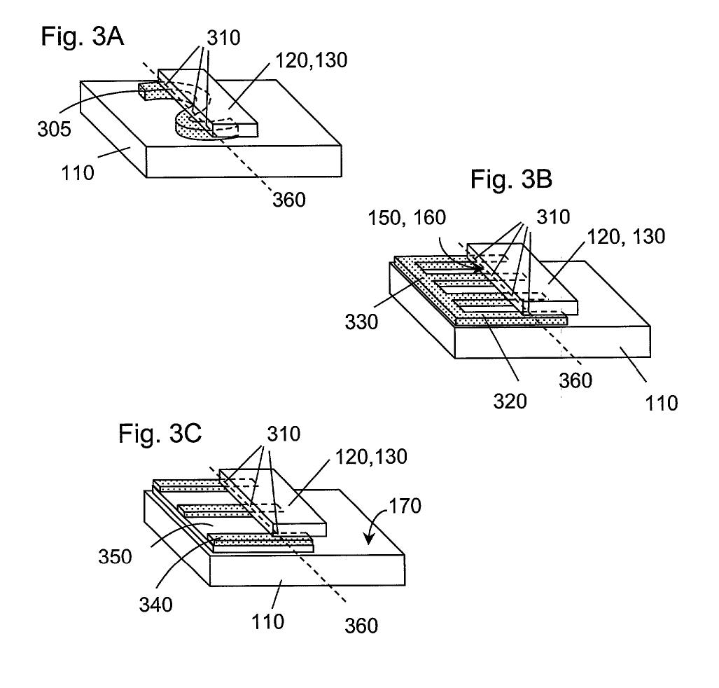

Alternatively, the standoff structure 140 may include a single continuous standoff that has at least two, and preferably at least three, contact portions providing support at locations spaced laterally across the optical array component and running substantially perpendicular to the plane that substantially contains the subject edge 150, 160 of the optical component. It will be apparent that the standoff structure should contact the optical array component at a plurality of contact portions of the standoff structure. Three example designs of standoff structures are illustrated in FIGS. 3A, 3B and 3C. FIG. 3A depicts a continuous serpentine-type structure 305 that has three contact portions 310 which provide support to the optical array 120, 130. FIG. 3B depicts a comb-type structure, which is another continuous structure comprising four substantially parallel teeth 320 joined at one end by a spine 330 which runs perpendicular to the four teeth 320. In this case, the spine 330 runs substantially parallel to the subject edge of the optical component 120, 130, and the teeth 320 provide the contact portions 310. FIG. 3C depicts a comb-type structure, which is still another continuous structure comprising three parallel teeth 340 (with contact portions 310) joined by a base 350. In this case, base 350 is in a plane which is substantially parallel to a major surface of optical component 120, 130, and is located such that one of its two major surfaces is in contact with the first major surface 170 of submount 110.

It is preferable that at least three of the contact portions 310 occur consecutively along a straight line 360 parallel to and close to subject edge 150, 160 of optical component 120, 130, and that those three contact portions 310 are mutually isolated from each other along line 360 in reference surface 250. Note that contact portions 310 may, however, connect with each other at locations spaced away from that straight line, and therefore may not be entirely isolated from each other; but they should be mutually isolated from each other at least along line 360 in reference surface 250 parallel to and in close proximity to subject edge 150, 160. Preferably, contact portions 310 are closer to subject edge 150,160 than the separation between the contact portions 310. FIGS. 3A, 3B and 3C depict non-limiting examples of structures which illustrate this point, but are only examples of the many different design options that may be appropriate.

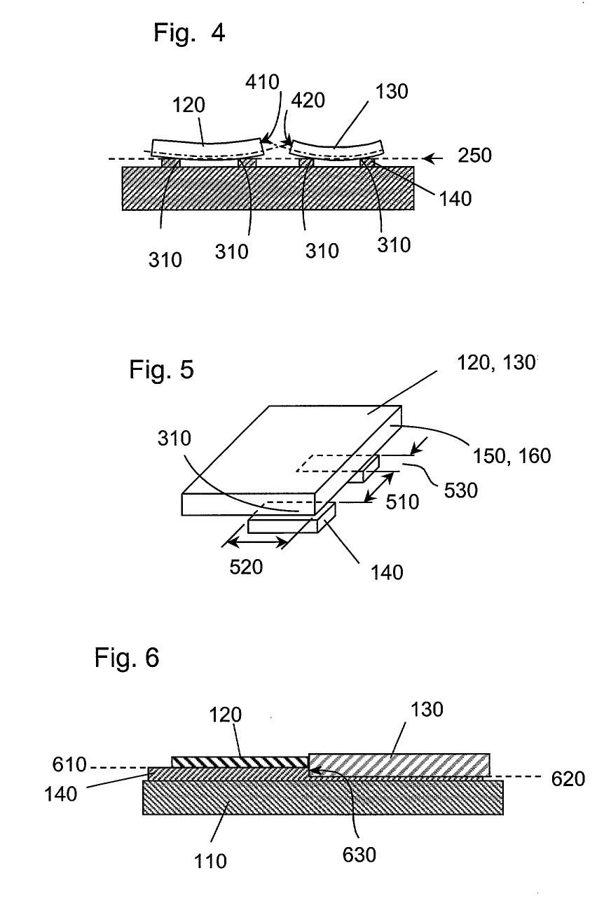

FIG. 4, for illustrative purposes, shows a cross-sectional view taken at the side-facets of two array components 120 and 130, having optical ports 410 and 420, which are waveguide inputs or outputs. It is noted that the cross section is here taken perpendicular to that shown in FIG. 2 and that the contact portions of the standoff structure are here discrete (discontiguous) in the longitudinal dimension generally parallel to the waveguides. As illustrated, although very much exaggerated, if care is not taken to select the appropriate size and location of the contact portions 310 of the standoff structure 140, which comprises discrete standoffs to support the optical component 120, 130, alignment of the two optical ports 410 and 420 may not be adequate to achieve optical alignment.

As illustrated in FIG. 5, the contact portions 310 of the discrete standoffs of the standoff structure 140 (i.e., the portions which make actual contact with the optical component 120, 130) should be sufficiently large in number, should have sufficiently narrow two-dimensional spacing 510, and extend over a sufficiently large portion 520 of the optical components 120, 130, to define the reference surface 250 adequately for the desired application. More specifically, in the lateral dimension along the subject edge 150, 160, the contact portions 310 need to be sufficient in number, spacing 510 and lateral extent to define the curvature of the subject edge adequately for the desired application. In the longitudinal dimension, the contact portions 310 should be sufficiently close to the subject edge 150, 160 and sufficiently long or closely spaced that they control the curvature of the subject edge 150, 160 adequately for the desired application. It is preferable that at least one contact portion 310 included under the optical component 120, 130 is sufficiently close to the subject edge 150, 160 to define the vertical angles of the optical axes of each of the optical ports adequately for the desired application.

In a typical embodiment, the aim is to achieve optical coupling between the two optical components 120,130 at the irrespective subject edges 150, 160, thus essentially aiming for minimal curvature in the proximity of the subject edges, at the point of coupling between the optical components.

There is no requirement that different portions of the standoff structure contacting at different positions under the optical component all have the same height. In some embodiments, desirable curvatures and optical axes angles are best achieved with non-uniform standoff structure heights. It will therefore be appreciated that some portions of the standoff structure may be short, either intentionally or unintentionally, and those do not count in the definition of the reference surface. One illustration of this concept is shown in FIG. 6, in which the stepped standoff structure 140 comprises two levels of standoff, the first level 610 being utilized to provide a first reference surface for the first optical array component 120, and the second level 620 being utilized to provide a second reference surface for the second optical array component 130. It should be noted that the two reference surfaces are not on the same plane relative to one another. As illustrated, this particular design may be useful when dealing with optical components of substantially different thickness, and in which the optical ports 190 of the second optical component 130 are in a higher plane than the optical ports 180 of the first optical component 120.

In addition, in the arrangement shown, the stepped standoff structure 140 provides a physical “stop” 630, a predetermined position for locating the second optical component 130 in that one dimension, thus allowing the second optical component 130 to be butt coupled to the first optical component 120 in a more precise manner. It will be apparent that such a protrusion element, functioning as a physical “stop” may be incorporated in the earlier embodiments described, and a stepped structure is not required to utilize this functionality. For example, a protrusion element between two sections of a standoff structure, wherein only one reference surface exists, may be useful in aligning two similar optical array components.

It will be appreciated that when a standoff structure 140 comprises several contact portions 310, if one particular contact portion is located on a higher plane than the others, this will not provide a good reference surface 250, since the number of contact points that can define the reference surface will be limited. However, if one particular contact portion is located on a lower plane than the other, this is an acceptable situation, since the number of contacts portions 310 that define the reference surface 250 will be dependent on all the remaining contact portions.

In addition, the contact portions of the standoff structure 140 that are under one optical component, for example the first optical array component 120 can be distinct (discontinuous from) from the contact portions that are under the second optical array component 130, or they can be continuous. In the case where the same submount 110 will be used for optical alignment of both the first 120 and the second optical array component 130, the standoff structure 140 should have at least longitudinal rigidity during and after bonding (which is explained below).

In the present invention, optical coupling between two IO components, or alternatively, one IO component and an array of fibers, is facilitated by referencing the centers of both sets of waveguides to the same reference surface 250. Referring to FIG. 2 again, the optical array component 120 is shown making uniform contact along its bottom surface 220 to the reference surface 250 and is held in that position by an adhesive, for example a glue, epoxy or other such bonding agent, such as solder balls 260, situated in the recesses between the discrete standoffs. The recesses between the discrete standoffs are wider than they are high, so that an approximately round solder ball in a recess could protrude above the reference surface in the absence of an array component, and yet not fill the recess when the array component is in its final position, in contact with the tops 210 of the discrete standoffs 140. The bonding agent, in this case the solder balls 260, does not completely fill the recesses, as shown, allowing for variation in the size of solder balls, or the quantity of adhesive dispensed, without affecting the contact between an array component and the reference surface. Note that the architecture described above and illustrated, is such that there is no adhesive or solder located between the optical array component and the contact portions of the standoff structure. This is advantageous in that the thickness or volume of bonding agent deposited in the recesses between the discrete standoffs does not affect the alignment of the optical array component.

As shown in FIG. 2, the total area of contact, that is the sum of the contact portion areas, between the standoff structure 140 and the optical array component 120 is less than the total area by which the submount 110 overlaps the optical array component 120. The overlap area is defined herein as the intersection area of a perpendicular projection of the optical component onto the submount. The total area of contact between the standoff structure 140 and the optical array component 120 is preferably less than 50%, and more preferably less than 10%, of the area by which the submount 110 overlaps the optical array component 120.

It is apparent to those skilled in the art that the particular choice of standoff structure 140 to define the reference surface 250, made in this invention, provides further advantages. A standoff structure provides higher fault tolerance for particulate matter defects, compared to a continuous support surface. For a given volume density of particulates in the ambient atmosphere, there is less chance of a random particle settling on a smaller area (representative of standoff structure 140) than on a larger area (representative of a continuous support surface). It will be appreciated that the minimum height of the standoff structure 140 at contact portions 310 should preferably at least be equal to the maximum particle size that is likely to be encountered in the processing environment. Another advantage is that standoff structure 140 may provide solder dams to prevent cross connection of any electrical connections that are made by means of solder balls in the recesses between portions of the standoff structure.

It is further apparent that the particular choice of a standoff structure 140 comprising a plurality of standoffs under the optical array component 120, 130 provides the capability of aligning components that are not inherently flat. Many types of optoelectronic and integrated optics chips are known to exhibit nonplanarities such as warping, curling, and bowing that can easily exceed the allowable coupling alignment tolerance. Such nonplanarities may result from stresses developed during various processing steps. It is therefore desirable to provide a method by which the optical port(s) of components such as IO chips may be brought into acceptable alignment even when one or both of the components exhibits a curvature which departs substantially from perfect planarity. The term curvature is used herein in its mathematical sense. All surfaces have a defined local radius of curvature, even those that are perfectly planar (for planar surfaces, the radius of curvature is infinite).

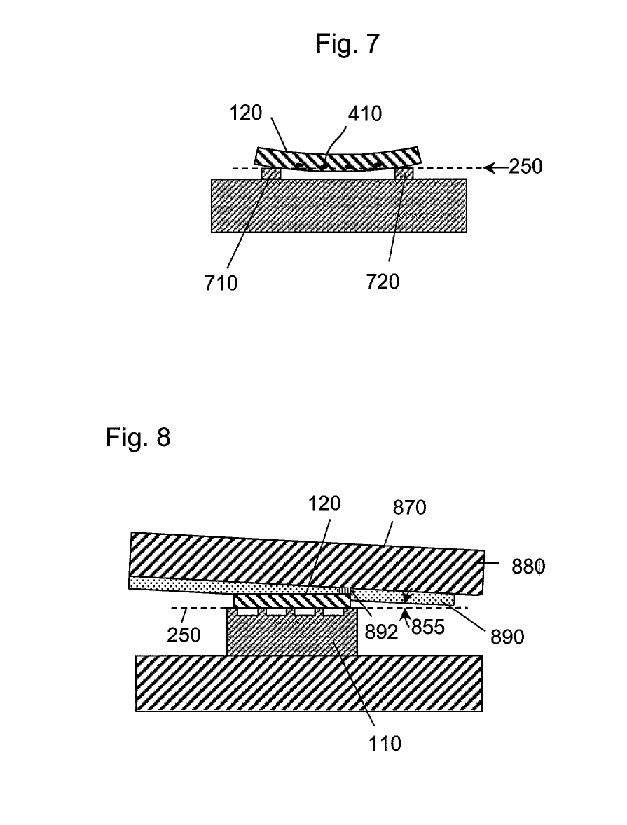

If a standoff structure 140 comprising two discrete standoffs is used, and these standoffs are located only at the perimeter of an optical array component 120, for example two longitudinally directed parallel standoffs 710 and 720 as shown in FIG. 7, it is apparent that the optical component 120 will retain a (pre-existing) nonplanar shape while resting on standoffs 710 and 720. Consequently, optical modes exiting the end-facet of the optical array component 120, via optical ports 410 at intermediate points between 710 and 720 will not be at a fixed distance from the reference plane 250 and not in general aligned with and well coupled to corresponding optical ports on the second optical array component 130, that may have a different curvature.

As illustrated by the present invention, a plurality of discrete standoffs under the optical array components, such as a parallel array of discrete standoffs shown in FIG. 1, defines a reference surface 250 across the entire width of a optical array component, and thereby, provided that either the standoff structure or the optical array component is able to flex and/or rotate, defines the vertical position of an optical component that is in substantially uniform contact with the discrete standoffs, across the entire dimensions of the optical array component. Referring to FIG. 1, the array component 120, 130 similarly makes uniform contact to the reference surface 250 and is held by adhesive or solder balls.

It should be noted that while the reference surface 250 is shown as a straight line in cross-sectional view and is therefore implied to be a plane in the drawings, it may alternatively have some nonplanarity without materially affecting the results of this invention. If a curved reference surface 250 is utilized (i.e., one having a finite radius of curvature), the optical components are preferably forced to substantially follow the same curvature along the subject edge. This may be useful in certain applications of the processes described herein.

The packaging arrangement of the present invention is enabled by an array scalable optical alignment process. The array scalable optical alignment process achieves simultaneous highly efficient coupling between each of the multiple ports in first optical array component and a respective second optical array component. The simultaneous coupling of all the ports reduces the number of ultra-high precision active alignment steps from one per port to one per optical array component.

For optical coupling of optical array components 120 and 130 using the techniques of the current invention, assuming that a single submount 110 is utilized, the submount 110 should be longitudinally rigid at least near the opposing subject edges of components 120 and 130, at least one of the three components 110, 120 and 130 should be longitudinally and laterally rigid. As used herein, “rigid” means substantially undeformed during assembly, and “substantially” is intended to accommodate manufacturing tolerances only; a rigid component is ideally intended to remain completely undeformed. This enables optical coupling to be achieved by employing the flip-chip bonding technique as mentioned above and flexing one component to conform to a substantially rigid reference surface. A capability of coupling flexible components may be particularly useful for packaging components constructed from polymer or other intrinsically flexible materials.

The above-referenced figures indicate the definitions of the bottom and the top sides of all the embodiments, and their variants shown in the figures thereof, in which it can be seen that all levels are described relative to a submount at the bottom of the structure. The terms “top” and “bottom”, “lower” and “upper” and the like are used herein solely for convenience in referring to particular levels. The levels they refer to are not intended to change if the structure is turned upside down or tilted.

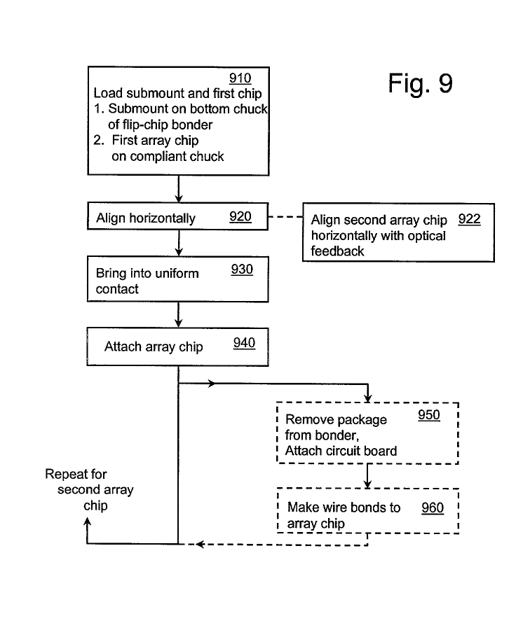

Assembly of the components to form the arrangement depicted in FIG. 1 is achieved using simultaneous optical alignment of all the optical ports 180 in the first optical array component 120 to corresponding optical ports 190 in the second optical array component 130. A process flow diagram of the assembly method is shown in FIG. 9. In the first step 910, the first optical array component is loaded onto the chuck of a flip chip bonder and held in position by, for example vacuum. This chuck may provide a conforming or deformable layer as described below. The submount along with the standoff structure are loaded onto a substrate holder.

In the second step 920, the first optical array component is aligned laterally and longitudinally substantially in the horizontal plane by a known method, such as using optical alignment to fiducial marks on the submount. It is also initially aligned to be approximately parallel to the major surface of the submount (roll and pitch angles) using an autocollimator, to the maximum accuracy provided by a standard flip-chip bonding system, but for optical alignment in the vertical direction further accuracy is typically required. For example, for an array component width of 10 mm the angular precision required to bring the bar within 0.5 μm of the submount (±0.25 μm tolerance) across the entire width is 3×10⁻³ degrees, or 10 seconds of arc. Maintaining this degree of parallelism as the submount and chuck are heated to melt the bonding agent (for example, solder) and brought into contact proves to be outside the capabilities of current state-of-the-art bonding equipment. It is observed that even if the array component and submount can at first be angularly aligned with the required accuracy, thermal expansion and mechanical misalignments during the approach to contact generally result in misalignment at the moment of contact. With conventional rigid chucks holding both the submount and array component, neither is free to move in roll or pitch to correct any misalignment and thus if bonding is done in this configuration, for instance by melting, flowing and then cooling of solder balls, the vertical position of the array component, relative to the reference surface on the submount, will vary across the width of the package. This variation cannot be predicted as it depends on the mechanical and thermal variations of the apparatus, which are not necessarily uniform or repeatable. In addition, if the optical array component is warped, curled or bowed, it will be apparent that use of a rigid chuck would result in contact being made with one point on the optical component before any other, hence resulting is a substantially non-uniform distance between the reference surface defined by the standoff structure and the vertical positioning of the optical ports in the optical array component.

The operation of the compliant/deformable layer mentioned above to alleviate the warp, bow and mechanical misalignments resulting from the flip chip bonder is illustrated in FIG. 8, which is a cross-sectional view taken at a line A-A identified in FIG. 1 or alternatively at another line approximately parallel to A-A.

As the chuck holding the component is moved towards the submount, a point on the component first contacts the reference surface. Thereafter, as the chuck continues to press toward the submount, in areas of the component in contact with the reference surface, the compliant material compresses while the component does not move, and in areas that are not in contact yet, the component moves and there is less compression of the compliant material. The compliant material holds the lateral and longitudinal positions of the component substantially fixed while deforming in the perpendicular direction to the submount. It is apparent that the force applied by the bonder to bring the two chucks (a first chuck holding the component and a second chuck holding the submount) closer together is distributed by the compliant layer, causing the force to act on a larger area of the component and thereby reducing the maximum stress applied in any local region of the component during assembly. Compression of the compliant material allows movement of the chuck to continue while the component pivots around the first contact point and also flexes if required to eliminate initial warp, curl, or bow, until it is in spatially uniform contact with the reference surface and no part of it can any longer move perpendicularly to the reference surface. End of chuck motion occurs at a given average pressure as determined by force sensors, or alternatively, strain sensors, incorporated in the equipment.

It will be appreciated that in order to provide an accurate reference surface, the standoff structure should have sufficient rigidity in the vertical dimension to withstand the pressures exerted by the chuck pressing against it. If the pressures are exerted at elevated temperatures, which might be the case if certain bonding agents such as solder are being used, then the vertical rigidity of the standoff structure should be maintained even at the elevated temperature. In this sense, a solder bump which is liquified during mounting does not qualify as part of a standoff structure.

In FIG. 8, there is shown a compliant chuck 870 holding a component 120, which is in spatially uniform contact with the reference surface 250. The chuck is shown to have a rigid part 880, and a compliant layer 890 covering at least a portion of its surface, that is compressed to various degrees in different areas. The degree of compression depends at a given point on the distance between the reference surface 250 and the rigid part 880, on the thickness of the component 120, and on warping stress in the component. In the case shown, the most compressed region 892 is indicated by shading.

Preferably the compliant layer acts as an elastic material such that it returns to its initial state after bonding is complete and the array component is released.

Standard flip-chip bonders are designed primarily to ensure contact and bonding to solder balls typically larger than 25 μm in diameter, for micro-electronic type applications, rather than the finer dimensional requirements of optoelectronic devices. Some existing bonders provide a self-leveling or a floating chuck to minimize tilt misalignment, but these can generally be used only with large-area components where the moment arm is long enough to provide the required leveling torque without damage to the component where it first contacts the package or substrate. However optoelectronic components such as LD arrays or bars are generally narrow and fragile and thus would be subject to excessive force and consequent damage, especially at the peripheral corners which have the all important optical ports, and where any damage is fatal to device performance. In addition, such chucks are generally designed simply to ensure that all solder contact pads make contact with rather large solder balls, so that there are no defects in the electrical connection to the component being bonded, and are not designed to provide co-planarization with sub-micron accuracy over millimeters of component width as required for IO packaging. Accordingly, the chuck is generally not parallel to the reference surface 250 on sub-micron scale, but is tilted by an angle 855, as shown exaggerated for purposes of illustration in FIG. 8. The angle 855 may vary in magnitude, and also in direction of tilt, for example upon heating.

Further, as noted above in the description associated with FIGS. 4 and 7, the optical array component is generally not flat but may be warped, curled, or bowed to some degree, that may exceed the said tolerance of optical alignment, which should be within approximately ±0.25 μm over the extent of the component. The compliant chuck and packaging method of this invention overcome these limitations, as described below.

The compliant material on the chuck is preferably elastic and recovers its normal shape when the chuck releases the component and retracts. Alternatively the chuck may be rigid and the compliant layer may be attached to the top major surface of the component that is facing the chuck, so that it does not interfere with the optical and/or electrical operation of the component. In this case the compliant material may be plastic rather than elastic as it is not re-used. In yet another embodiment the compliant material may be (or may be part of) a loose layer disposed between the chuck and the component, and not attached to either.

The compliant material must give in the vertical direction without significantly shifting the position of the optical component in either of the two transverse directions, thus preserving the alignment of the component relative to the submount. The layer preferably (a) resists sideways motion also known as squirm that would change the lateral, longitudinal or rotational alignment in an uncontrollable manner, (b) provides a degree of compression or compliance in the vertical direction in order to take up or compensate for angular misalignment between the optical component and the submount, and (c) maintains these properties at the bonding temperature, which may be up to several hundred degrees centigrade. Further preferred properties of the layer are (d) a non-sticky surface for ease of component release, (e) support of vacuum-hold holes, and (f) elasticity without permanent denting, with recovery of initial compliance between bonding processes. This does not imply that the layer must be anisotropic in physical properties. In practice, thin layers of nominally isotropic materials are found to perform acceptably in this application.

It is apparent to those skilled in the art that the extra mechanical degrees of freedom to allow the “in process” pressure responsive adjustment of IO component tilt and curvature have not previously been shown.

In the next step 940 of the packaging method of FIG. 9, once the array component 120 is uniformly contacted to the standoff structures across the submount it is affixed or bonded in place using the chosen bonding agent, e.g. solder or epoxy, securing it in accurate alignment and relative position to the reference surface 250 defined by the standoff structures. In the case of solder, the bonding is accomplished by heating the chuck and submount, so that the solder 260 that is between the discrete standoffs melts, balls up, and contacts the bonding pads on the bottom surface of the array component, as indicated symbolically in the cross-sectional view, FIG. 2. The parts are then cooled and the solder 260 solidifies, thereby fixing the array component in position on the submount. The bonded array component and submount are hereafter termed a device, which now may be removed from the flip-component bonder. Alternatively, a thermal or UV curing adhesive may be used for the attachment, cured as known in the art. This process facilitates simultaneous, efficient optical alignment and coupling from the multiple emitters/waveguides/broad planar waveguide of component 120 to corresponding structures in a second array/IO component 130, which may be accomplished as a single alignment process step.

At this point the attachment process may be repeated with the second optical array component, starting from step 910. Alternatively in the case where the array components are optoelectronic, electro-optic, or other types of devices requiring electrical connection for their functioning, as opposed to passive optical or integrated optical array components which do not require such connection, a circuit substrate such as a printed wiring board or a flex board may be attached by solder or other adhesive to the device, indicated as step 950 of FIG. 9. As a further alternative, such a circuit substrate is attached prior to step 910 of this procedure, in which case step 950 may be omitted.

Once a circuit board is attached, wire bonds may then be made for electrical connection between an array component and the circuit substrate, noted as step 960 in FIG. 9.

The packaging method for a second optical array component is substantially similar to that for a first optical array component including steps 910 to 940 given in FIG. 9 with one main exception, in that the lateral alignment may be made with optical feedback if desired. In place of 920 a modified horizontal alignment step 922 may be employed in which one or more light beams are provided to be emitted from the first optical array component of the device. The second optical array component is held on a compliant chuck attached to a computer controlled multi-axis micropositioning machine capable of submicron positioning accuracy and repeatability, such as an autoalign system. It is initially aligned relative to the device (bonded first array component and submount) using optical alignment and fiducial marks to set lateral and longitudinal position and yaw angle, and an autocollimator to set parallelism to the submount (roll and pitch angles) as in step 920. It is then brought into close proximity to the reference surface 250 and its receiving end positioned adjacent to the edge of the first array component emitting the said array of light beams. It will be understood that this alignment method is based on butt coupling between the components, requiring close approach of the facets of the two components to avoid diffraction losses between the two. If the first optical array component is a diode laser array or other array light source, it is electrically powered to cause emission of light beams from the array. If the first component is a passive waveguide array, a suitable external light source may be coupled to its input. The light is captured by the receiving waveguides in the second component. A photodetector or other suitable detector is situated at the output side of the second component and monitors the light output of its waveguide array structures. The position of the second component is then adjusted under computer control relative to the said array of light beams, to the position of maximum light transmission through its waveguide structures. In case the component is an optoelectronic array with no optical output, such as a photodetector array, the lateral alignment is made to an electrically indicated maximum response position. Importantly, adjustment is performed only in the lateral, longitudinal, and yaw dimensions as the vertical position and the pitch and roll angles are defined by the reference surface of the standoff array.

Once the desired position of the second optical array component has been reached and memorized, the compliant chuck is moved away from its alignment position by the multi-axis micropositioning machine and adhesive is dispensed between the discrete standoffs. The multi-axis micropositioning machine is then utilized to return the second optical component to its exact memorized position. Alignment is confirmed, and the adhesive provided with the means to set, and provide mechanical stability. For example if a UV curable epoxy is utilized, the epoxy is exposed to UV to enable it to cure, and hence set as required for its desired utilization.

Alternatively the second optical component 130 may be located relative to fiducial marks on the submount or the first optical component 120 (or a combination of both) without further optical feedback, to provide optical alignment and coupling between the components. In this case machine vision systems known in the art can provide fully automated alignment and bonding of the second component relative to the first.

It is apparent to those skilled in the art that array components with different dimensions and materials of construction will be employed in different applications, and consequently the details of carrying out the packaging method of this invention will vary according to the application.

Preferred Embodiment and Method

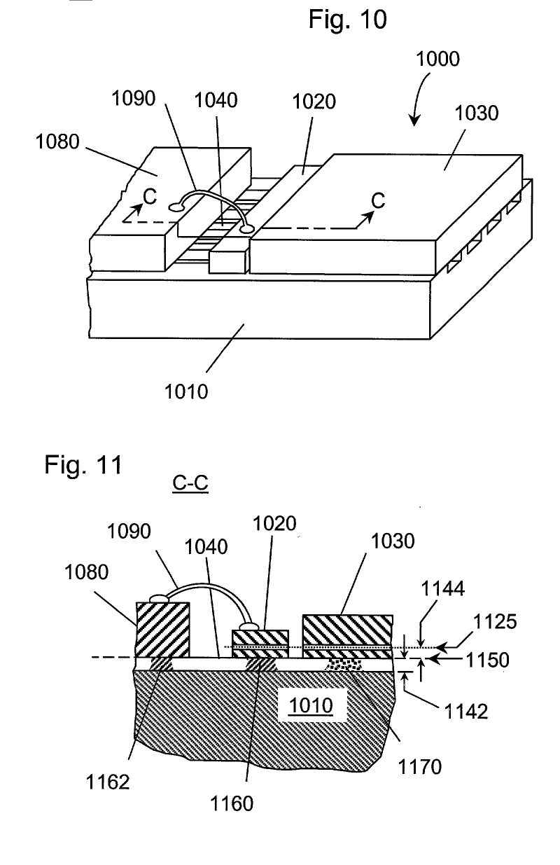

Referring to FIGS. 10 and 11, there is shown a preferred array device 1000 comprising a single crystal silicon submount 1010, a diode laser array chip 1020 herein called a laser bar, and a lithium niobate waveguide array chip 1030 herein called a LN WG chip, constructed according to the method of this invention. The laser bar 1020 in this example is 10 mm wide as measured in the direction indicated by the arrows labeled C in FIG. 10, 0.5 mm long, and 0.1 mm thick, and contains around 100 individual diode lasers also called stripes or emitters. A standoff structure 1040, comprising a series of parallel, longitudinally oriented rib standoffs, is shown on the surface of the submount 1010. The upper surfaces of the standoffs define a reference surface 1150. The standoffs are fabricated by photolithography and etching, using one of the standard processes employed in silicon wafer fabrication. The height 1142 of the standoff structures is around 0.005 mm, and their width and spacing under the laser bar are 0.03 mm and 0.1 mm, respectively; and under the LN WG chip, 0.1 mm and 0.2 mm, respectively.

Submount 1010 is preferably fabricated from single-crystal silicon, or alternatively, from other materials such as polymers, composites, alumina, AlN and BeO to provide better thermal expansion match or better thermal conductivity as required in different applications.

The laser bar 1020 and the LN WG chip 1030 are fabricated and prepared by methods well known in the art and may have specific features or properties to better suit them to packaging/mounting according to this invention. For example, the laser array/bar 1020 may have metallic bonding pads arranged on its emitter side major surface to provide robust contacting to the mounting solder (the solder that performs the mounting function).

The LN WG chip 1030 may have a layer of material deposited on the waveguide top surface to match the height of the optical mode with that of the diode laser 1020 when the major surfaces of each chip are contacted to the reference surface 1150. The thickness of the required layer may be determined from optical characterization measurements of the output mode of the LN WG chip as known in the art, or by theoretical modeling of the waveguide structure. The height-matching layer may be any hard material with a refractive index sufficiently lower than LN so as not to distort the waveguide properties, and with sufficient adhesion, thermal expansion matching and chemical stability.

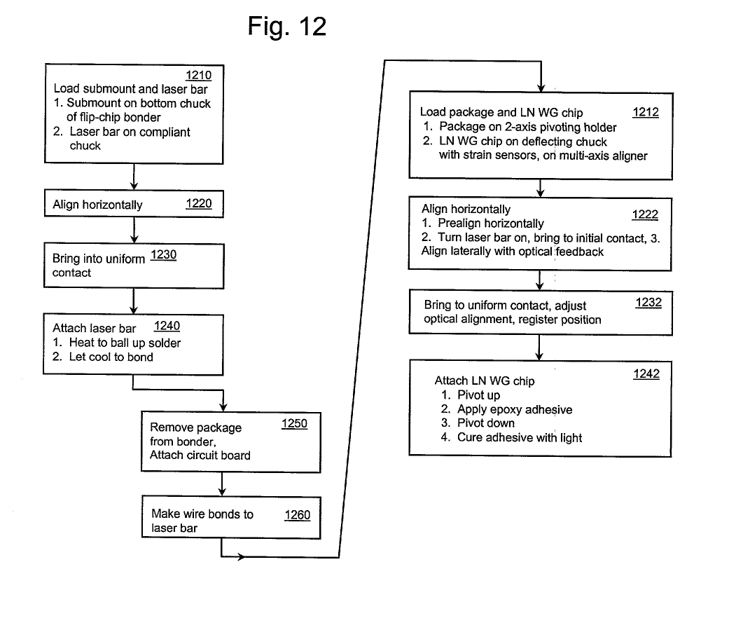

A process flow diagram showing a preferred method to construct the planar array device 1000 is shown in FIG. 12. In the first step 1210 of the method, the laser bar 1020 is loaded emitter side down on a compliant chuck fitted on a standard flip-chip bonder, where the laser bar is held firmly by vacuum. The submount 1010 is loaded on the substrate holder. In the second step 1220 the laser bar 1020 is aligned laterally and longitudinally substantially in the horizontal plane, to fiducial marks on the submount 1010, and it is also aligned to be approximately parallel to the surface of the submount.

In the third step 1230, the compliant chuck is moved relative to the submount 1010, to bring the laser bar 1020 into uniform contact with the tops 1150 of the standoff structures on the submount 1010, as shown in cross-sectional view in FIG. 11. In the chuck, a compliant or rubbery layer of material is interposed between the array chip and the rigid part of the chuck, which allows the chuck to “give” or compress as contact is made. Examples of materials suitable for the compliant layer include silicone rubber, polyimide, Teflon or other fluorocarbons, epoxies, fluoroelastomers such as Viton® (manufactured by DuPont Dow Elastomers), and other high temperature adhesives or encapsulants. As one point of the array chip contacts before the rest, the compliant layer of the chuck is compressed at that point enabling the laser bar to pivot through a small angle (and also to flex if required to accommodate preexisting warping or other nonplanarity) needed to bring the rest of it into contact with 1150.

In the next step 1240, the laser bar 1020, placed in uniform contact with the standoff structure 1040 comprising discrete standoffs, is attached to the submount 1010 preferably by means of low-creep solder. The chuck and submount 1010 are heated so that the solder 1060 in the recessed parts of the submount surface between the discrete standoffs, melts, balls up, and contacts the bonding pads on the bottom surface of the laser bar 1020, as shown in FIG. 11. An alternative procedure which achieves the same result is to (a) make uniform contact to the solder bumps 1060, the solder bumps extending above the height of the standoff structure and (b) heat the submount and vacuum chuck to reflow the solder, while maintaining uniform pressure. The solder melts and the laser bar is pushed down to make contact with the discrete standoffs. It should be noted that other solder bumps/balls 1162 and the bonding material 1170 shown in the figure are not yet present on the submount during step 1240. The parts are then cooled and the solder 1160 solidifies, thereby fixing the laser bar in position on the submount and providing p-side electrical connections to it. The bonded laser bar and submount are hereafter termed a device.

The device is then removed from the flip-chip bonder and a circuit board, which is preferably a flex board 1080, is attached to the device by means of solder 1162, comprising step 1250 of FIG. 12. In the next step 1260, wire bonds 1090 are made to contact pads on top of the laser bar, providing n-side electrical circuit connections to it. It should be noted that there may be a plurality of wire bonds to the emitters on the laser bar, but only one is shown, for purposes of clarity.

The procedure continues with assembly of the LN WG chip 1030 to the device. The chip 1030 and laser bar 1020 have been so constructed that the individual optical mode center lines of the arrays are spaced substantially the same distance apart, and situated substantially the same distance 1144 above their respective bottom surfaces at the point of coupling between the chips, thus ensuring existence of a good alignment position as indicated in FIG. 11. In cross-sectional view, the center lines of a typical waveguide structure in 1020 and, in 1030 are shown to coincide in a common center line 1125. Note that away from the point of coupling, the waveguides may, alternatively, curve in the plane of the array or surface, or dip into the substrate (i.e. alter their position relative to the reference surface) as necessary to fulfill the optical function of the chip. In step 1212 the device and the LN WG chip 1030 are loaded onto a multi-axis aligner. The device is held in a computer controlled 6-axis manipulator, and the chip is held by a deflecting-type compliant chuck on a fixed stand with high-precision pivoting capability. In the said chuck the chip is held on a rigid plate and compliance is provided by 2-axis bending elements behind the plate, with separate strain sensors monitoring the deflection in each axis. There is a photodetector situated at the output side of the LN WG chip whereby the light output of the waveguide array structures of the chip can be monitored. Alignment is preferably performed under computer control.

The device and LN WG chip 1030 are aligned horizontally in step 1222 in three sub-steps, first approximately in the correct position laterally and horizontally and major surfaces approximately parallel. Second, the laser bar 1020 is turned on by applying electrical power, thereby providing an array of one or more light beams emitted by the individual diode lasers of the bar 1020, and the device is moved toward the LN WG chip 1030 to initial contact position as detected by the said strain sensors. Third, the device with the said array of light beams is laterally aligned relative to the LN WG chip 1030, to the position of maximum light transmission through its waveguide structures as detected by the said photodetector.

In the next step 1232 the device is brought to full uniform contact with the LN WG chip 1030. As one point of the chip 1030 contacts before the remainder of the chip, bending elements of the chuck deform as necessary to enable pivoting through the small angle required to bring the chip into full contact, as detected by the strain sensors. The alignment is readjusted for maximum light transmission, and the position is registered.

In the last step 1242 of the preferred method, the device is withdrawn from the LN WG chip 1030 after the position of the autoalign stage has been recorded. The stages, which offer position repeatability of better than 0.1 μm allow the device to be removed and later restored to effectively the same position. Once the device is withdrawn UV curing epoxy is dispensed into the desired recesses or wells between the discrete standoffs and the device returned to the recorded position relative to the LN WG chip 1030. Final alignment of the two components is performed followed by curing of the epoxy by application of the appropriate wavelength of light. For example, if the epoxy is Norland Optical Adhesive 68, UV light at a wavelength of 350-380 nm and a recommended energy dose of 4.5 joules per centimeter squared should be applied to achieve full curing.

In the example described above, it may appear that the submount has no functionality other than as a support structure for the standoff structure and indirectly the optical array components too. However if one should, for example, require additional functionality, that may be added to the submount. For example, the submount may provide for thermal management (heat spreading management) or routing of electrical signals. For instance, in this particular embodiment, in which the first optical array component is a laser bar, one may desire to drive the individual laser emitters individually. To accommodate this functionality, one may consider building a drive chip, for example an ASIC (application-specific integrated circuit), into the submount. In this manner, the close spacing of the individual emitters and the close spacing of additional laser diode arrays would not be considered detrimental to the need of individual addressability, or create a real estate issue.

Another Embodiment and Method

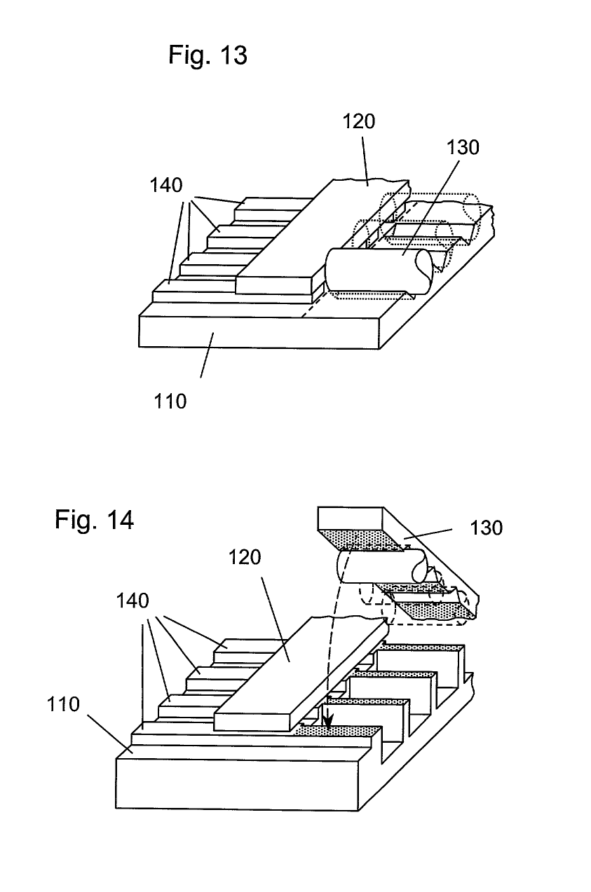

It will be apparent that a standoff structure according to the present invention is not necessarily required to align both optical array components on a submount. FIG. 13 illustrates an embodiment in which a first optical array component 120 is coupled to a second optical array component, that is an array of optical fibers 130. As illustrated, the first optical component 120 is mounted on a standoff structure 140, which is fabricated on a major surface of the submount 110. The standoff structure does not however continue beyond the first optical array component 120. The optical fiber array 130 is held in place via a series of V-grooves, a well known technology. Note that the figure shows only the lower portion of the V-groove structure; ordinarily, an upper portion that may comprise a V-groove structure or alternatively, a planar substrate, is also utilized such that an optical fiber is completely encased and located by the combination of the upper and lower portions.

In this arrangement, the array of optical fibers 130 is aligned such that the optical mode centroids of each of the individual fibers are in a common plane, a function provided by the V-groove architecture. It will be apparent that one would therefore require that (a) the first optical component 120 be aligned such that its input/output optical ports also lie in a common plane, and (b) that the plane be situated at an appropriate height to align with the mode centroids of the array of optical fibers 130. The standoff structure 140 in this instance provides for a reference surface 250 that accomplishes such alignment.

FIG. 13 illustrates an embodiment which takes the architecture illustrated in FIG. 12 but utilizes the standoff structure not only to align the first optical array component 120, but to also align the array of optical fibers 130. In this case, only an upper V-groove structure is utilized. Once again, the first optical component 120 is mounted on a standoff structure 140, which is fabricated on a major surface of the submount 110. The standoff structure 140 extends beyond the first optical array component 120 and into an area housing the optical fiber array 130. The optical fiber array 130 is once again held in place via a series of V-grooves, but this time, by only the upper portion of the V-groove structure. As illustrated, there is no lower portion V-groove structure. Instead, the submount is prepared by removing sufficient submount material to enable the optical fibers to be located in the recesses therein, and without allowing the fibers to be undesirably restrained by the recess walls.

Once again, in this arrangement, the array of optical fibers 130 is aligned such that the centroids of each of the individual fibers is in a common plane, a function provided by the upper portion of the V-groove architecture.

In this arrangement, the first optical array component 120 is aligned by utilizing the standoff structure 140, as described earlier. The extended standoff structure is fabricated such that when the lower major surface of the upper V-groove architecture is brought into contact with the contact portions of the extended standoff structure (as indicated symbolically by a dashed arrow and shaded matching contact portions in FIG. 14), the optical ports of the first optical array are aligned with the mode centroids of the optical fibers.

In general, the alignment tolerances for optical coupling between the output waveguides of an optical waveguide array component such as a LN WG chip and an optical fiber array are considerably looser (i.e. larger) than those for coupling between a laser diode array chip, herein called a laser bar, and the input waveguides. This is because the size of the optical mode in a single mode optical fiber is typically large, approximately 6 μm diameter for 980 nm fiber and 9 μm for 1480 nm fiber, and the mode at the output of the LN WG chip is required to be approximately the same size, to ensure efficient butt coupling. A small misalignment on sub micron scale has only a minor effect on overlap between optical modes that are several micrometers in size and, accordingly, has a only a small effect on the coupling efficiency to a fiber array. On the other hand, at the input side the mode size would be dictated by the much smaller mode of a laser diode, approximately 1 μm in the vertical direction at 980 nm, and thus much tighter tolerances of alignment are required. It is known in the art that the mode size may be expanded within a waveguide array component, to accommodate different coupling requirements at its input and output facets.

As illustrated and described, we have discussed the optical aligning of a first optical array component to a second optical array component, in which the submount has been common between the two. It will be appreciated that this concept may be extended to any number of optical array components. For example, a first optical array component may be optically aligned to a second optical array component, both the first and second components sharing a common first submount which incorporates a first standoff structure facilitating a first reference surface. A third optical array component may then optically aligned to the second optical array component, however the third optical array component has its own submount, of a differing thickness to the first submount, and possibly accommodating a second standoff structure facilitating a second reference surface. Hence any combination of submounts and standoff structures is possible, enabling various reference surfaces to be utilized, and hence enabling optical array components of various sizes and thicknesses to be accommodated.

Furthermore, although the current invention has been described in which the optical components have been primarily been considered as waveguide array chips or arrays of optical fibers, one will appreciate that the invention is not intended to be limited to such optical devices. One of the aims of the current invention is to provide a means by which the optical ports on a subject edge of a first optical array component, for example output ports, can be optically aligned and hence coupled to the optical ports on a subject edge of a second optical array component, for example input ports. However, although it is preferred that these optical ports be spaced substantially the same distance apart (as described earlier), it is not essential that the optical port spacing be preserved across the optical array component in either case. Hence these optical ports, for example the input facet of an optical fiber, may taper outwards to create a larger optical array component, or even a device. It is, for example possible that the current invention be applied to the optical alignment of a laser bar to a display panel that comprises electrically-controlled waveguide routing, as described in U.S. Pat. No. 5,544,268 to Bischel et al., incorporated by reference herein.

In many of the embodiments described herein, there is a one-to-one correspondence between the ports on two adjacent optical array components. Each port on one of the components communicates exclusively with a single corresponding port on the other optical component. It will be appreciated, however, that many aspects of the invention are not limited to use with such components. For example, in one embodiment, a first optical component includes a planar waveguide having a laterally wide optical port. The second optical component mounted on the same submount may be an optical array component which includes multiple ports all arranged to communicate optically with the single planar waveguide port of the first optical component. In another embodiment, both optical components have planar waveguides and communicate with each other via respective wide optical ports.

As used herein, a given event is “responsive” to a predecessor event if the predecessor event influenced the given event. If there is an intervening processing element, step or time period, the given event can still be “responsive” to the predecessor event. If the intervening processing element or step combines more than one event, the signal output of the processing element or step is considered “responsive” to each of the event inputs. If the given event is the same as the predecessor event, this is merely a degenerate case in which the given event is still considered to be “responsive” to the predecessor event. “Dependency” of a given event upon another event is defined similarly.

The foregoing description of preferred embodiments of the present invention has been provided for the purposes of illustration and description. It is not intended to be exhaustive or to limit the invention to the precise forms disclosed. Obviously, many modifications and variations will be apparent to practitioners skilled in this art. In particular, and without limitation, any and all variations described, suggested or incorporated by reference in the Background section of this patent application are specifically incorporated by reference into the description herein of embodiments of the invention. The embodiments described herein were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

What is claimed is:

1. A mounting method for optical components, comprising the steps of:
providing a submount having a standoff structure protruding from a first surface thereof;
pressing a first optical component against the standoff structure such that at least one of said submount and said first optical component deforms and said first optical component contacts said standoff structure in a first plurality of contact portions of said standoff structure; and
bonding said first optical component to said submount.

2. A method according to claim 1, wherein after said step of pressing, said standoff structure contacts said first optical component over a total contact area which is less than the total area by which said first optical component overlaps said submount.

3. A method according to claim 1, wherein said first plurality of contact portions includes all points on said standoff structure which contact said first optical component after said step of pressing,
and wherein at least two consecutive ones of said contact portions along a straight line are mutually isolated from each other along said straight line.

4. A method according to claim 3, wherein said step of bonding said first optical component to said submount comprises the steps of:
applying an epoxy between two of said contact portions on said submount; and
after said step of pressing, curing said epoxy.

5. A method according to claim 3, wherein said step of bonding said first optical component to said submount comprises the steps of:
flowing solder between two of said contact portions on said submount; and
after said step of pressing, cooling said solder.

6. A method according to claim 3, further comprising the step of forming solder bumps between said contact portions on said submount,
wherein said step of bonding said first optical component to said submount is performed as part of said step of pressing said first optical component against said standoff structure.

7. A method according to claim 1, wherein said first plurality of contact portions includes all points on said standoff structure which contact said first optical component after said step of pressing,
wherein said first optical component includes a plurality of optical ports arranged along a first edge of said first optical component,
and wherein at least three consecutive ones of said contact portions along a straight line parallel to said first edge of said first optical component are mutually isolated from each other along said straight line.

8. A method according to claim 1, wherein said first optical component is an optical array component.

9. A method according to claim 1, wherein said first optical component comprises an optical emitter.

10. A method according to claim 1, wherein said first optical component comprises an optical detector.

11. A method according to claim 1, wherein said first optical component comprises an optical fiber array.

12. A method according to claim 1, wherein said first optical component is formed on a chip, and wherein said step of pressing deforms said first optical component and substantially not said submount.

13. A method according to claim 12, wherein said step of pressing flattens said first optical component.

14. A method according to claim 1, wherein said step of pressing deforms said submount to conform to curvature of said first optical component.

15. A method according to claim 1, wherein said first optical component includes a first plurality of optical ports,
further comprising, after said step of bonding, the step of attaching a second optical component to said submount such that a first optical port of said second optical component can communicate optically with at least one of the optical ports of said first optical component.

16. A method according to claim 15, wherein said step of attaching comprises the step of attaching said second optical component such that the first optical port of said second optical component can communicate optically with more than one of the optical ports of said first optical component.

17. A method according to claim 16, wherein said second optical component comprises a planar waveguide, and wherein the first optical port of said second optical component comprises an edge of said planar waveguide.

18. A method according to claim 15, wherein said second optical component includes a plurality of optical ports including said first optical port of said second optical component,
and wherein said step of attaching comprises the step of attaching said second optical component such that each of the optical ports of said second optical component can communicate optically with a respective one of the optical ports of said first optical component.

19. A method according to claim 15, wherein said step of attaching comprises the steps of:
pressing said second optical component against said standoff structure such that at least one of said submount and said second optical component deforms and said second optical component contacts said standoff structure in a second plurality of contact portions of said standoff structure; and
bonding said second optical component to said submount.

20. A method according to claim 19, wherein said standoff structure comprises a plurality of ribs arranged such that each rib includes a respective first segment which is in said first plurality of contact portions and a respective second segment which is in said second plurality of contact portions.

21. A method according to claim 19, wherein said first optical component comprises a plurality of optical emitters and said second optical component comprises a plurality of optical detectors,
and wherein said step of attaching comprises the step of attaching said second optical component such that each of said optical detectors can communicate optically with a respective one of the optical emitters of said first optical component.

22. A method according to claim 19, wherein said first optical component comprises a plurality of optical emitters and said second optical component comprises an optical fiber array having a plurality of fiber ends,
and wherein said step of attaching comprises the step of attaching said optical fiber array such that each of said fiber ends can communicate optically with a respective one of the optical emitters of said first optical component.

23. A method according to claim 19, wherein said step of pressing said second optical component against said standoff structure deforms said second optical component and substantially not said submount.

24. A method according to claim 19, wherein said step of pressing said second optical component against said standoff structure flattens said second optical component.

25. A method according to claim 19, wherein said step of pressing said first optical component against said standoff structure deforms said submount to conform to curvature of said first optical component,
and wherein said step of pressing said second optical component against said standoff structure deforms said second optical component to conform to curvature of said submount.

26. A method according to claim 25, wherein said step of pressing said first optical component against said standoff structure deforms said submount laterally across but substantially not perpendicularly to said first plurality of optical ports

27. A method according to claim 19, wherein said second optical component comprises a plurality of optical ports, and wherein said step of attaching further comprises the steps of:
activating one of said first and second optical components to emit optical energy and monitoring optical energy captured by the other of said first and second optical components; and
repositioning said second optical component laterally relative to said submount in response to said step of monitoring.

28. A method according to claim 27, wherein said step of repositioning includes the step of repositioning said second optical component longitudinally relative to said submount in response to said step of monitoring.

29. A method according to claim 27, wherein said steps of monitoring and repositioning are performed prior to said steps of pressing said second optical component against said standoff structure and bonding said second optical component to said submount.

30. A method according to claim 19, wherein said first optical component is formed on a first chip, the optical ports in said first plurality of optical ports being located on a first edge of said first chip,
and wherein said second optical component comprises a second chip having a second plurality of optical ports located on a second edge of said second chip,
further comprising the step of forming additional material on a first major surface of said first chip prior to said step of pressing a first optical component against said standoff structure, such that the optical ports in said first plurality of ports are located on said first edge at the same distance away from said first major surface as the second ports are located away from a major surface of said second chip.

31. A method according to claim 19, wherein said first optical component is formed on a first chip, the optical ports in said first plurality of optical ports being located on a first edge of said first chip,
and wherein said second optical component comprises a second chip having a second plurality of optical ports located on a second edge of said second chip,
further comprising the step of forming additional material on a second major surface of said second chip prior to said step of pressing a second optical component against said standoff structure, such that the optical ports in said first plurality of ports are located on said first edge at the same distance away from said first major surface as the second ports are located away from a major surface of said second chip.

32. A method according to claim 19, wherein said second optical component further has a second optical port,
further comprising, after said step of attaching a second optical component, the step of attaching a third optical component to said submount such that a first optical port of said third optical component can communicate optically with the second optical port of said second optical component.

33. A method according to claim 1, wherein said first optical component includes first and second opposite major surfaces, and wherein said step of pressing comprises the steps of
affixing said first surface of said first optical component to a surface of a chuck, said first surface and said chuck being spaced from each other by a compliant layer;
moving said chuck such that said second surface of said optical component contacts said standoff structure; and
pressing said chuck toward said submount until said first optical component deforms to contact said standoff structure in said first plurality of contact portions.

34. A method according to claim 33, wherein said step of affixing comprises the step of vacuum mounting said first surface of said first optical component to said compliant surface of said chuck through said compliant layer.

35. A method according to claim 34, wherein said step of moving comprises the step of positioning said first optical component first within a plane parallel to said submount, prior to said step of pressing.

36. A method according to claim 33, wherein said compliant layer is attached to said chuck surface.

37. A method according to claim 1, wherein said first optical component further includes a second standoff structure protruding toward said submount.

38. A method according to claim 37, wherein after said step of pressing, said submount contacts said second standoff structure in a second plurality of contact portions of said second standoff structure.

39. A mounting method for an optical array chip having first and second opposite major surfaces, comprising the steps of:
providing a submount having a standoff structure protruding from a first surface thereof;
affixing said first surface of said optical array chip to a surface of a chuck, said first surface and said chuck being spaced from each other by a compliant layer;
pressing said chuck toward said submount, said second major surface of said optical array chip making contact with said standoff structure on said submount such that said chip deforms to contact said standoff structure in a plurality of contact portions of said standoff structure, said plurality of contact portions including all points on said standoff structure which contact said optical array chip after said step of pressing, at least two consecutive ones of said contact portions along a straight line being mutually isolated from each other along said straight line; and
bonding said first optical array component to said submount.

40. A method according to claim 39, wherein said optical array chip includes a plurality of optical ports along a subject edge thereof,
and wherein said standoff structure includes at least three ribs which, after said step of pressing, are partially under said optical array chip and also extend out from under said optical array chip at said subject edge.

41. A mounting method for a second optical array chip having first and second opposite major surfaces and further having a subject edge having a plurality of optical port located thereon, comprising the steps of:
providing a submount having a standoff structure protruding from a first surface thereof, said submount further having bonded thereto a first optical chip having a subject edge having at least one optical port located thereon;
affixing said first surface of said second optical array chip to a compliant surface of a chuck;
positioning said second chip above said standoff structure such that the subject edges of said first and second chips are facing each other;
activating one of said first and second chips to emit optical energy and monitoring optical energy captured by the other of said first and second chips;
repositioning said second chip laterally relative to said submount in response to said step of monitoring;
pressing said chuck toward said submount, said second major surface of said second optical array chip making contact with said standoff structure such that said second chip deforms to contact said standoff structure in a plurality of mutually isolated contact portions of said standoff structure; and
bonding said second optical array chip to said submount.

42. A method for making an optical fiber array, comprising the steps of:
providing a submount having a plurality of longitudinal parallel recesses in a top surface thereof;
providing a fiber holder having a plurality of parallel v-grooves in an undersurface thereof, each of said v-grooves having a respective optical fiber affixed therein; and
attaching said fiber holder to said submount, said first surface of said fiber holder facing said first surface of said submount, and said fibers depending below the undersurface of said fiber holder and into said recesses in said first submount.

43. A method according to claim 42, wherein one of said undersurface of said fiber holder and said first surface of said submount has a standoff structure protruding therefrom, such that after said step of attaching, the undersurface of said fiber holder is spaced from said first surface of said submount by said standoff structure.

44. A method according to claim 43, wherein after said step of attaching, the other of said undersurface of said fiber holder and said first surface of said submount contacts said standoff structure in a first plurality of contact portions of said standoff structure, said first plurality of contact portions including all points on said standoff structure which contact said other of said undersurface of said fiber holder and said first surface of said submount,
and wherein said at least three consecutive ones of said contact portions along a straight line are mutually isolated from each other along said straight line.

45. A method according to claim 43, wherein said standoff structure comprises a plurality of ribs oriented parallel to said optical fibers.

46. A method according to claim 43, wherein said step of attaching comprises the step of applying a bonding material to bond said undersurface of said fiber holder to said first surface of said submount, none of said bonding material being located on any region of said standoff structure which makes contact with said other of said undersurface of said fiber holder and said first surface of said submount.

47. Optical apparatus comprising:
A submount having a standoff structure protruding from a first surface thereof;
a first optical chip bonded to said submount, said first optical chip having a first optical port; and
a second optical chip attached to said submount such that a first optical port of said second optical chip can communicate optically with said first optical port of said first optical chip,
wherein said first optical chip contacts said standoff structure over a first total contact area which is less than the total area by which said first optical chip overlaps said submount.

48. Apparatus according to claim 47, wherein said first total contact area is less than 50% of the total area by which said first optical chip overlaps said submount.

49. Apparatus according to claim 47, wherein said first total contact area is less than 10% of the total area by which said first optical chip overlaps said submount.

50. Apparatus according to claim 47, wherein said second optical chip contacts said standoff structure over a second total contact area which is less than the total area by which said second optical chip overlaps said submount.

51. Apparatus according to claim 47, wherein said first optical chip includes a first plurality of optical ports including said first optical port of said first optical chip,
wherein said first optical port of said second optical chip can communicate optically with at least said first optical port of said first optical chip.

52. Apparatus according to claim 51, wherein said second optical chip comprises a planar waveguide,
wherein the first optical port of said second optical chip comprises an edge of said planar waveguide,
and wherein said second optical chip is attached to said submount such that the first optical port of said second optical chip can communicate optically with more than one of the optical ports of said first optical chip.

53. Apparatus according to claim 51, wherein said second optical chip includes a plurality of optical ports including said first optical port of said second optical chip,
and wherein said second optical chip is attached to said submount such that each of the optical ports of said second optical chip can communicate optically with a respective one of the optical ports of said first optical chip.

54. Apparatus according to claim 47, further comprising a bonding material bonding said first optical chip to said submount, none of said bonding material being located on any region of said standoff structure which makes contact with said first optical chip.

55. Apparatus according to claim 54, wherein said bonding material is a member of the group consisting of an epoxy and a solder.

56. Apparatus according to claim 54, wherein said standoff structure comprises a plurality of ribs,
and wherein said bonding material is disposed only between said ribs.

57. Optical apparatus comprising:
a submount having a standoff structure protruding from a first surface thereof; and
a first optical component bonded to said submount, said first optical component contacting said standoff structure in a first plurality of contact portions of said standoff structure, said first plurality of contact portions including all points on said standoff structure which contact said first optical component,
wherein at least three consecutive ones of said contact portions along a straight line are mutually isolated from each other along said straight line.

58. Apparatus according to claim 57, wherein said first optical component contacts said standoff structure over a total contact area which is less than the total area by which said first optical component overlaps said submount.

59. Apparatus according to claim 58, wherein said total contact area is less than 50% of the total area by which said first optical component overlaps said submount.

60. Apparatus according to claim 58, wherein said total contact area is less than 10% of the total area by which said first optical component overlaps said submount.

61. Apparatus according to claim 57, further comprising an epoxy bonding said first optical component to said submount, said epoxy being located between two of said contact portions on said submount and not on any of said contact portions.

62. Apparatus according to claim 57, further comprising solder bonding said first optical component to said submount, said solder being located between two of said contact portions on said submount and not on any of said contact portions.

63. Apparatus according to claim 57, wherein said first optical component includes a plurality of optical ports arranged along a first edge of said first optical component,
and wherein at least three consecutive ones of said contact portions along a straight line parallel to said first edge of said first optical component are mutually isolated from each other along said straight line parallel to said first edge.

64. Apparatus according to claim 57, wherein said first optical component is an optical array component.

65. Apparatus according to claim 57, wherein said first optical component comprises an optical emitter.

66. Apparatus according to claim 57, wherein said first optical component comprises an optical detector.

67. Apparatus according to claim 57, wherein said first optical component comprises an optical fiber array.

68. Apparatus according to claim 57, wherein said first optical component includes a first plurality of optical ports,
further comprising a second optical component attached to said submount in such a way that a first optical port of said second optical component can communicate optically with at least one of the optical ports of said first optical component.

69. Apparatus according to claim 68, wherein the first optical port of said second optical component can communicate optically with more than one of the optical ports of said first optical component.

70. Apparatus according to claim 69, wherein said second optical component comprises a planar waveguide, and wherein the first optical port of said second optical component comprises an edge of said planar waveguide.

71. Apparatus according to claim 68, wherein said second optical component includes a plurality of optical ports including said first optical port of said second optical component,
and wherein said second optical component is attached to said submount in such a way that each of the optical ports of said second optical component can communicate optically with a respective one of the optical ports of said first optical component.

72. Apparatus according to claim 68, wherein said second optical component contacts said standoff structure in a second plurality of contact portions of said standoff structure.

73. Apparatus according to claim 72, wherein said standoff structure comprises a plurality of ribs arranged such that each rib includes a respective first segment which is in said first plurality of contact portions and a respective second segment which is in said second plurality of contact portions.

74. Apparatus according to claim 72, wherein said first optical component comprises a plurality of optical emitters and said second optical component comprises a plurality of optical detectors,
and wherein said first and second optical components are attached to said submount in such a way that each of said optical detectors can communicate optically with a respective one of the optical emitters of said first optical component.

75. Apparatus according to claim 72, wherein said first optical component comprises a plurality of optical emitters and said second optical component comprises an optical fiber array having a plurality of fiber ends,
and wherein said first and second optical components are attached to said submount in such a way that each of said fiber ends can communicate optically with a respective one of the optical emitters of said first optical component.

76. Apparatus according to claim 72, wherein said second optical component further has a second optical port,
further comprising a third optical component attached to said submount in such a way that a first optical port of said third optical component can communicate optically with the second optical port of said second optical component.

77. Optical apparatus comprising:
a submount having a standoff structure protruding from a first surface thereof; and
an optical array chip bonded to said submount in such a way that said chip contacts said standoff structure in a plurality of contact portions of said standoff structure, said plurality of contact portions including all points on said standoff structure which contact said optical array chip, at least three consecutive ones of said contact portions along a straight line being mutually isolated from each other along said straight line.

78. Apparatus according to claim 77, wherein said optical array chip includes a plurality of optical ports along a subject edge thereof,
and wherein said standoff structure includes at least three ribs which are partially under said optical array chip and also extend out from under said optical array chip at said subject edge.

79. Optical apparatus comprising:
a submount having a standoff structure protruding from a first surface thereof;
a first optical chip attached to said submount and having a subject edge on which is located at least one optical port, said first optical chip contacting said standoff structure in a first plurality of at least three mutually isolated contact portions of said standoff structure; and
a second optical array chip attached to said submount and having a subject edge on which is located a plurality of optical ports, the subject edge of said second optical array chip facing the subject edge of said first optical chip, and said second optical array chip contacting said standoff structure in a second plurality of at least three mutually isolated contact portions of said standoff structure.

80. Optical fiber array apparatus, comprising:
a submount having a plurality of longitudinal parallel recesses in a top surface thereof;
a fiber holder attached to said submount, said fiber holder having an undersurface facing said top surface of said submount, said fiber holder having a plurality of parallel v-grooves in said undersurface; and
a plurality of optical fibers each affixed in a respective one of said v-grooves and depending below the undersurface of said fiber holder and into said recesses in said first submount.

81. Apparatus according to claim 80, further comprising a standoff structure spacing said undersurface of said fiber holder from said first surface of said submount.

82. Apparatus according to claim 81, wherein said standoff structure includes at least three portions which are disposed consecutively along a straight line and which are mutually isolated from each other along said straight line.

83. Apparatus according to claim 81, wherein said standoff structure comprises a plurality of ribs oriented parallel to said optical fibers.

84. Apparatus according to claim 81, further comprising a bonding material bonding said undersurface of said fiber holder to said first surface of said submount, none of said bonding material being located on any region of said standoff structure which makes contact with either of said undersurface of said fiber holder and said first surface of said submount.

85. A mounting method for optical components, comprising the steps of:
providing a submount having a standoff structure protruding from a first surface thereof;
juxtaposing a first optical component against the standoff structure such that said first optical component contacts said standoff structure in a first plurality of contact portions of said standoff structure, said first plurality of contact portions including all points on said standoff structure which contact said first optical component after said step of juxtaposing; and
bonding said first optical component to said submount with a bonding agent which contacts said submount only in regions thereof other than on said contact portions,
wherein said at least three consecutive ones of said contact portions along a straight line are mutually isolated from each other along said straight line.

86. A method according to claim 85, wherein said first plurality of contact portions have a total contact area which is less than the total area by which said first optical component overlaps said submount.

87. A method according to claim 85, wherein said step of bonding said first optical component to said submount comprises the steps of:
applying an epoxy between two of said contact portions on said submount; and
after said step of juxtaposing, curing said epoxy.

88. A method according to claim 85, wherein said step of bonding said first optical component to said submount comprises the steps of:
flowing solder between two of said contact portions on said submount; and
after said step of juxtaposing, cooling said solder.

89. A method according to claim 85, further comprising the step of forming solder bumps between said contact portions on said submount,
wherein said step of bonding said first optical component to said submount is performed as part of said step of juxtaposing said first optical component against said standoff structure.

90. A method according to claim 85, wherein said first optical component includes a plurality of optical ports arranged along a first edge of said first optical component,
and wherein said straight line is a straight line parallel to said first edge of said first optical component.

91. A method according to claim 90, wherein first and second consecutive mutually isolated contact portions along said straight line are spaced from each other by a first inter-standoff spacing,
and wherein said straight line is a straight line that is closer to said first edge than said first inter-standoff spacing.

92. A method according to claim 85, wherein said first optical component is an optical array component.

93. A method according to claim 85, further comprising, after said step of juxtaposing, the step of pressing a first optical component against the standoff structure such that at least one of said submount and said first optical component deforms.

94. A method according to claim 85, wherein said first optical component includes a first plurality of optical ports,
further comprising, after said step of bonding, the step of attaching a second optical component to said submount such that a first optical port of said second optical component can communicate optically with at least one of the optical ports of said first optical component.

95. A method according to claim 94, wherein said second optical component comprises a planar waveguide, and wherein said step of attaching comprises the step of attaching said second optical component such that an edge of said planar waveguide can communicate optically with more than one of the optical ports of said first optical component.

96. A method according to claim 94, wherein said second optical component includes a plurality of optical ports including said first optical port of said second optical component,
and wherein said step of attaching comprises the step of attaching said second optical component such that each of the optical ports of said second optical component can communicate optically with a respective one of the optical ports of said first optical component.

97. A method according to claim 94, wherein said step of attaching comprises the steps of:
juxtaposing said second optical component against the standoff structure such that said first optical component contacts said standoff structure in a second plurality of contact portions of said standoff structure, said second plurality of contact portions including all points on said standoff structure which contact said second optical component after said step of juxtaposing; and
bonding said second optical component to said submount with a bonding agent which contacts said submount only in regions thereof other than on the contact portions in said second plurality of contact portions.

98. A method according to claim 97, wherein said standoff structure comprises a plurality of ribs arranged such that each rib includes a respective first segment which is in said first plurality of contact portions and a respective second segment which is in said second plurality of contact portions.

99. A method according to claim 97, wherein said second optical component comprises a plurality of optical ports, and wherein said step of attaching further comprises the steps of:
activating one of said first and second optical components to emit optical energy and monitoring optical energy captured by the other of said first and second optical components; and
repositioning said second optical component laterally relative to said submount in response to said step of monitoring.

100. A method according to claim 97, wherein said first optical component is formed on a first chip, the optical ports in said first plurality of optical ports being located on a first edge of said first chip,
and wherein said second optical component comprises a second chip having a second plurality of optical ports located on a second edge of said second chip,
further comprising the step of forming additional material on a first major surface of said first chip prior to said step of juxtaposing a first optical component against said standoff structure, such that the optical ports in said first plurality of ports are located on said first edge at the same distance away from said first major surface as the second ports are located away from a major surface of said second chip.

101. A method according to claim 97, wherein said first optical component is formed on a first chip, the optical ports in said first plurality of optical ports being located on a first edge of said first chip,
and wherein said second optical component comprises a second chip having a second plurality of optical ports located on a second edge of said second chip,
further comprising the step of forming additional material on a second major surface of said second chip prior to said step of juxtaposing a second optical component against said standoff structure, such that the optical ports in said first plurality of ports are located on said first edge at the same distance away from said first major surface as the second ports are located away from a major surface of said second chip.

102. A method according to claim 97, wherein said second optical component further has a second optical port,
further comprising, after said step of attaching a second optical component, the step of attaching a third optical component to said submount such that a first optical port of said third optical component can communicate optically with the second optical port of said second optical component.

103. A mounting method for optical components, comprising the steps of:
providing a first optical component having a standoff structure protruding from a first surface thereof;
pressing a submount against the standoff structure such that at least one of said submount and said first optical component deforms and said submount contacts said standoff structure in a first plurality of contact portions of said standoff structure; and
bonding said first optical component to said submount.

104. Optical apparatus comprising:
A first optical component having a standoff structure protruding from a first surface thereof; and
a submount bonded to said first optical component, said submount contacting said standoff structure over a total contact area which is less than the total area by which said first optical component overlaps said submount.

105. Optical apparatus comprising:
a first optical component having a standoff structure protruding from a first surface thereof; and
a submount bonded to said first optical component, said submount contacting said standoff structure in a first plurality of contact portions of said standoff structure, said first plurality of contact portions including all points on said standoff structure which contact said submount,
wherein at least three consecutive ones of said contact portions along a straight line are mutually isolated from each other along said straight line.

106. A mounting method for optical components, comprising the steps of:
providing a first optical component having a standoff structure protruding from a first surface thereof;
juxtaposing a submount against the standoff structure such that said submount contacts said standoff structure in a first plurality of contact portions of said standoff structure, said first plurality of contact portions including all points on said standoff structure which contact said submount after said step of juxtaposing; and
bonding said first optical component to said submount with a bonding agent which contacts said first optical component only in regions thereof other than on said contact portions,
wherein said at least three consecutive ones of said contact portions along a straight line are mutually isolated from each other along said straight line.
